(19) United States
(12) Patent Application Publication
(10) Pub. No.: US 2024/0174878 A1
(43) Pub. Date: May 30, 2024

(54) Thermochromic Liquid Crystal Inks

(71) Applicant: Sun Chemical B.V., Weesp (NL)

(72) Inventors: Roger Jacot, Niederwangen (CH); Kurt Klaus, Niederwangen (CH); Stefan Küffer, Niederwangen (CH)

(21) Appl. No.: 18/433,903

(22) Filed: Feb. 6, 2024

Related U.S. Application Data
(62) Division of application No. 17/604,680, filed on Oct. 18, 2021, now abandoned.

(51) Int. Cl. C09D 11/50; B41M 5/00; C09D 11/033; C09D 11/037; C09D 11/107; C09D 11/14; C09K 19/36; C09K 19/52; C09K 19/54

(52) U.S. Cl. CPC C09D 11/50; B41M 5/0023; C09D 11/033; C09D 11/037; C09D 11/107; C09D 11/14; C09K 19/36; C09K 19/544; C09K 2019/523

(57) ABSTRACT

The present invention provides thermochromic liquid crystal inks and coatings. The ink and coating compositions comprise one or more non-encapsulated cholesteryl materials, one or more resins that are not cholesteryl materials, and one or more solvents. In certain embodiments, a thermochromic effect is observed at about body temperature.

### FIELD OF THE INVENTION

The present invention relates to thermochromic liquid crystal inks. Temperature-sensitive, i.e. thermochromic, liquid crystals exist in an intermediate mesophase between an anisotropic crystal phase and an isotropic phase, within a specified temperature range. When in the mesophase, the liquid crystals reflect light of a particular color, depending on the structural properties of the liquid crystals. Thermochromic liquid crystal inks are useful to detect temperature changes in an object.

### BACKGROUND OF THE INVENTION

Special effect inks have grown increasingly popular as customers are continuously seeking attractive displays for various end use applications.

One particular technology area that has shown traction in the marketplace is the use of thermochromic liquid crystal inks. The structure and physics of thermochromic liquid crystals gives them unique properties (see W. Elser and R. D. Ennulat, Adv. Liq. Cryst. 2, 73 (1976). Thermochromic liquid crystal inks preferably exhibit reversible color change that starts as either a colorless or light white-grey appearance, and then transitions into a more distinct color after being exposed to elevated temperatures, for example above room temperature. The thermochromic liquid crystal ink subsequently returns to its former colorless or white-grey upon removal of the heat source, as the temperature decreases. One of the drawbacks of to the current state of thermochromic ink technology is the requirement to use encapsulated liquid crystals, which require long processing times and limit the formulation latitude.

Previous attempts to formulate non-encapsulated liquid crystal thermochromic effect printing inks have not been successful. In general, the degree of stability of non-encapsulated liquid crystal liquids is insufficient for successful commercial exploitation in the majority of applications (see L C R Hallcrest Handbook of Thermochromic Liquid Crystal Technology (2014), page 10). This likely due to formulations not having the proper degree of flexibility in the ink films or basing the formulations on materials that are incompatible with liquid crystal thermochromic effect materials. Flexibility in this context can be understood to be the ink matrix surrounding the liquid crystals to provide sufficient room for the liquid crystals to arrange themselves during the drying process and in the final cured ink film.

There is no particular limitation to the end use applications for liquid crystal thermochromic effect inks as they could be used for packaging, security documents (e.g. banknotes, brand protection, identification documents (e.g. passport, driver's license), etc.), various displays, or virtually any other application in which a color change phenomenon is appropriate.

U.S. Pat. No. 3,620,889 describes a composition that can be used as a coating on an object, comprising liquid crystals admixed with a plastic resin solution. The amount of liquid crystals that can be used in these compositions is limited (in a ratio of liquid crystals:resin of about 0.07:1 to 0.21:1). Moreover, the change observed upon heating is a change from a clear to a cloudy condition. The color change is obscure, and may not occur at all, in these coatings.

U.S. Pat. No. 4,022,706 describes water-based cholesteric liquid crystal inks. The liquid crystal inks contain about 40 wt % to 75 wt % water. The liquid crystal film is believed to be a matrix of liquid crystal particles distributed relatively discontinuously in the film-forming polymer.

U.S. Pat. No. 5,805,245 discloses liquid crystals dispersed in films which are stacked in planar layers. The liquid crystal compositions comprise liquid crystals dissolved in solvent, and a water-based emulsion of a film forming polymer.

There is still a need for thermochromic liquid crystal inks that do not require encapsulated liquid crystals, provide the desired color changes at certain temperatures, and are stable.

### SUMMARY OF THE INVENTION

The present invention provides improved thermochromic liquid crystal inks. The present invention also provides printed/coated substrates, and methods of preparing same, comprising the ink and coating compositions of the present invention. Also provided are articles comprising the ink and coating compositions of the present invention. The ink and coating compositions of the present invention comprise non-encapsulated liquid crystals. The present invention is the first time that it has been shown that a sufficiently temperature sensitive and stable ink or coating composition can be formulated with non-encapsulated liquid crystal pigments.

In a particular aspect, the present invention provides a method of providing a reversible thermochromic printed or coated substrate, comprising:
(a) providing a substrate;
(b) applying one or more layers of an ink or coating composition to the substrate, wherein the ink comprises;
   i. one or more cholesteryl materials that are non-encapsulated; wherein each cholesteryl material has an anisotropic phase to mesophase threshold transition temperature TLC1, and a mesophase to isotropic phase threshold transition temperature TLC2;
   ii. one or more organic solvents; and
   iii. one or more resins that are not cholesteryl materials;
drying the composition on the substrate to form a reversible thermochromic ink film.

In certain embodiments, the ink and coating compositions of the present invention comprise 1 wt % to 30 wt % one or more cholesteryl materials, 1 wt % to 55 wt % one or more resins that are not cholesteryl materials, and 1 wt % to 80 wt % one or more solvents.

In some embodiments, the cholesteryl materials have an anisotropic phase to mesophase threshold transition temperature TLC1 of about −20° C. to about 100° C. In certain embodiments, the cholesteryl materials have a mesophase to isotropic phase threshold transition temperature TLC2 of about −19° C. to about 125° C. In certain embodiments, the cholesteryl materials have a bandwidth WLC (i.e. TLC2−TLC1) in which a color change is exhibited of about 1° C. to about 25° C.

In some embodiments, the ink and coating compositions of the present invention have an anisotropic phase to mesophase threshold transition temperature T1 of about −20° C. to about 100° C. In certain embodiments, the ink and coating compositions of the present invention have a mesophase to isotropic phase threshold transition temperature T2 of about −19° C. to about 125° C. In certain embodiments, the ink and coating compositions have a bandwidth W (i.e. T2−T1) in which a color change is exhibited of about 1° C. to about 25° C.

These and other objects, advantages, and features of the invention will become apparent to those persons skilled in the art upon reading the details of the formulations and methods as more fully described below.

### DETAILED DESCRIPTION OF THE INVENTION

It is to be understood that the foregoing general description and the following detailed description are exemplary and explanatory only, and are not restrictive of any subject matter claimed.

Headings are used solely for organizational purposes, and are not intended to limit the invention in any way.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

### Definitions

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise. Also, when it is clear from the context in which it is used, “and” may be interpreted as “or,” such as in a list of alternatives where it is not possible for all to be true or present at once.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

It is to be understood that wherein a numerical range is recited, it includes the end points, all values within that range, and all narrower ranges within that range, whether specifically recited or not.

As used herein, “substrate” means any surface or object to which an ink or coating can be applied. Substrates include, but are not limited to, cellulose-based substrates, paper, paperboard, fabric, leather, textiles, felt, concrete, masonry, stone, plastic, plastic or polymer film, glass, ceramic, metal, wood, composites, combinations thereof, and the like. Substrates may have one or more layers of metals or metal oxides, or other inorganic materials. In the present invention, preferred substrates are paper, paperboard, and polymer films, such as, but not limited to, polyethylene, polypropylene, oriented polypropylene (OPP), polyethylene terephthalate (PET), and the like.

As used herein, a “printed substrate” means a substrate to which an ink or coating has been applied and dried or cured. Methods of application include any known printing or coating method. For example, application methods include, but are not limited to, flexography, rotogravure, gravure, lithography, screen printing, curtain coating, roll coating, slot die coating, inkjet, etc. A printed substrate may include one or more layers of ink or coating, which may be the same or different from each other.

As used herein, the term “article” or “articles” means a substrate or product of manufacture. Examples of articles include, but are not limited to: substrates such as cellulose-based substrates, paper, paperboard, plastic, plastic or polymer film, glass, ceramic, metal, composites, and the like; and products of manufacture such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metallized foil (e.g. laminated aluminum foil), metallized polyester, a metal container, and the like.

As used herein, the terms “ink(s) and coating(s),” “ink(s),” and “coating(s)” all refer to the liquid crystal formulations of the present invention. It is understood that these terms are used interchangeably, and where one is recited, any of the other terms also apply.

As used herein, “cholesterol,” “cholesteryl,” “cholesteryl derivative,” and the like mean a compound that has cholesterol as the main structure. For example, cholesterol benzoate and cholesteryl benzoate refer to the same substance.

As used herein, “TLC1” refers to the anisotropic phase to mesophase threshold transition temperature of one or more liquid crystals as neat materials (i.e. containing only liquid crystal materials).

As used herein, “TLC2” refers to the mesophase to isotropic phase threshold transition temperature of one or more liquid crystals as neat materials (i.e. containing only liquid crystal materials).

As used herein, “WLC” is the temperature range, or bandwidth, through which the liquid crystal materials are in the mesophase and exhibit a color. “WLC” is the difference between TLC2 and TLC1 (i.e. TLC2−TLC1). WLC may be expressed as a number in degrees Celsius X° C. (e.g. 1° C.) or just as a number X. When WLC is expressed as just a number, it is understood that it is in degrees Celsius. For example, if a cholesteryl material has a TLC2 of 21° C. and a TLC1 of 20° C., the bandwidth WLC can be expressed as 1° C., or as 1. The bandwidth WLC is expressed as an absolute value (i.e. without regard to sign).

As used herein, “T1” refers to the anisotropic phase to meshophase threshold transition temperature of an ink or coating composition of the present invention.

As used herein, “T2” refers to the mesophase to isotropic phase threshold transition temperature of an ink or coating composition of the present invention.

As used herein, “W” is the temperature range, or bandwidth, through which the ink or coating composition of the invention is in the mesophase and exhibits a color. “W” is the difference between T2 and T1 (i.e. T2−T1). W may be expressed as a number in degrees Celsius (e.g. 1° C.) or just as a number (e.g. 1). When W is expressed as just a number, it is understood that it is in degrees Celsius. For example, if a composition has a T2 of 21° C. and a T1 of 20° C., the bandwidth W can be expressed as 1° C., or as 1. Bandwidth W is expressed as an absolute value (i.e. without regard to sign).

Throughout this disclosure, all parts and percentages are by weight (wt % or mass % based on the total weight) and all temperatures are in ° C. unless otherwise indicated.

### Thermochromic Liquid Crystals, Inks, and Coatings

Conventionally, matter exists in three states: solid (anisotropic), liquid (isotropic), and gas. However, certain crystalline materials exhibit intermediate phases, called mesophases, between the anisotropic and isotropic phases. Such materials are referred to as liquid crystals. In the mesophases they exhibit both solid-like and liquid-like properties. The anisotropic (crystalline) phase possesses long range three dimensional molecular order. The isotropic (liquid) phase has no long range molecular order. The mesophases have varying degrees of molecular order.

There are two types of liquid crystals. Lyotropic liquid crystals originate from a solution from an amphiphilic phase and a solvent, and change color with changes in the concentration of the solution. Thermotropic liquid crystals are temperature sensitive, and change color with changes in temperature. Thermotropic liquid crystals result from the melting of mesogenic (liquid crystal forming) solids by heating the materials to a temperature above which the crystal lattice is no longer stable, but is still sufficient that the material is not isotropic.

The liquid crystals are characterized by shape. They can be either calamitic (rod-like) shaped, or discotic (disc-like) shaped. The next level of classification is by phase. As discussed above, below a certain temperature they are generally in an anisotropic, crystalline state. Upon heating, they transition through one or more mesophases, then into the isotropic phase.

The mesophases are smectic, nematic, and cholesteric, and are defined by their molecular structure. Technically the cholesteric phase is often considered to be a sub-type of the nematic phase, termed the “chiral nematic phase.” In the present application we will refer to the cholesteric phase. The term cholesteric phase is used because the properties of the cholesteric phase were first observed in cholesterol and cholesteryl derivatives. But it should be noted that more recently, there has been interest in non-sterol chiral nematic materials, and it is intended that the present invention would equally apply to non-sterol chiral nematics.

Smectic mesophases are characterized by the long axes of the molecules being parallel, and by a layering of the molecular centers of gravity in two dimensional planes or sheets. The molecular centers of gravity are mobile in two directions, resulting in a characteristic layered structure. The smectic mesophase is the most solid-like of the liquid crystal mesophases.

In the nematic phase, the degree of molecular randomness is greater than in smectics. The long axes of the molecules remain substantially parallel, but the centers of gravity are mobile in three directions, and no discrete molecular layers can be identified. The average molecular direction is defined by a unit director.

The cholesteric or chiral nematic mesophase is the phase most associated with the unique optical properties of liquid crystals. The cholesteric materials are extremely optically active, rotating the plane of linearly polarized light. The optical activity is much more than can be accounted for on the basis of the constituent molecules alone. In the cholesteric phase, the molecules have a twisted, or chiral, structure. The preferred direction of the long axes of the molecules (the molecular director) is not constant. Passing through the sample in the direction of the optic axis (i.e. at right angles to the long molecular axes), the molecular director displays a continuous twist from one layer of molecules to the next. Within each plane molecular layer, the parallel alignment of the molecules is similar to that of a nematic. However, functional side groups extend out of the plane of the essentially flat constituent molecules. In order to spatially accommodate these functional groups, each layer must be slightly twisted with respect to those adjacent to it. The effect is cumulative, resulting in an overall helicoidal architecture. On a larger scale, the molecular director traces out a helix in space. Because of the twisted structure, cholesterics are usually more viscous than nematics, but are still more mobile than smectics.

It is the chiral structure of the cholesterics that leads to the color changing properties. The structural parameters affect what color light is reflected, resulting in a color change. Cholesteric mesophases are comprised of helical aggregates of molecules, and the longitudinal dimensions (i.e. along the axis of the helix) of these aggregates are of the order of the wavelength of visible light. These structures can be viewed as sheets of molecules. Within each sheet, the molecules behave like nematics, and have an average direction defined by a unit director, 1′. The degree of twist is quantified by the pitch length or periodicity, P. The periodicity P of the helix is defined as the longitudinal distance through which this director has to pass to make a complete 360° revolution. Consequently, each molecule is skewed at some angle, θ, with respect to its neighbors in adjacent sheets, immediately above and below. The angle θ is referred to as the displacement angle. The twist can be right handed or left handed.

The liquid crystal materials of the present invention have an anisotropic phase to mesophase threshold temperature TLC1, below which the liquid crystal materials are in an anisotropic, crystalline state. In the anisotropic state, the liquid crystals are generally colorless, or a light white/grey color. As the liquid crystal material is heated above TLC1, it transitions into the mesophase. It is in the mesophase that the liquid crystal material displays a characteristic color, depending on the wavelength of light that is reflected. As heating is continued, a mesophase to isotropic phase threshold temperature TLC2 is reached, where the liquid crystal transitions from the mesophase to the isotropic phase. In the isotropic phase, the liquid crystals are generally colorless or a light white/grey color. The temperature range, or bandwidth, WLC, through which the liquid crystal materials exhibit a color is the difference between TLC2 and TLC1 (TLC2−TLC1). The liquid crystals may exhibit a range of colors as the temperature is changed. The range of colors may include, as the temperature is increased, red, orange, yellow, green, blue, and possibly violet.

The liquid crystal materials in non-encapsulated form are difficult to use. They are oily substances and are not very stable. If used in coatings or inks, they tend to migrate out of the coating or ink film. To overcome these problems, it is generally accepted that to be used in an ink or coating composition, the liquid crystals must be encapsulated.

The present invention is directed to ink and coating compositions that comprise non-encapsulated liquid crystal materials as thermochromic, color changing pigments. In one embodiment, the inks of the present invention would exhibit color change due to the elevated temperature, such as, for example, associated with touch by humans, and would revert back to their original appearance upon removal of the heat from human touch.

In a preferred embodiment, the inks of the present invention would incorporate cholesteryl derivatives, possibly in combination with other resins. The use of cholesteryl derivatives, for example cholesteryl esters, has been described previously. However, there is no teaching of the use of non-encapsulated liquid crystal pigments in printing inks.

There is no particular limitation on the substrates that could be used for the inks of the present application. Although the examples provided herein were performed on a paper substrate pre-printed with black (to enhance the visual color change effect), the inks could be formulated for use on any substrate, e.g. polymeric films, paper and board, metal and metal foils, glass, etc.

There is no particular limitation on the type of inks that could be formulated from this technology. An able formulator would be able to provide flexographic, offset, offset with flexographic print station, gravure, screen, digital, lithographic, etc. inks based on this technology. Inks could be solvent-based, water-based, energy curable, hybrid, etc.

In a preferred embodiment, the inks of the present invention would undergo a reversible color change upon exposure to heat generated from human touch (approximately 37° C.), and revert back to its initial colorless or low color intensity after cooling down below this temperature to near room temperature (approximately 18° C. to 25° C.). In other preferred embodiments, the inks of the present invention would be useful for packaging for cooled food and drinks, and the reversible color change would occur upon cooling to a desired consumption temperature (approximately 2° C. to about 6° C.).

In other embodiments, the materials used in the inks of the present invention could be formulated to undergo reversible color change at different temperatures. For example, the color change could be activated at very low temperatures (e.g. less than 0° C., as in a freezer), and reversed at room temperature, or vice versa. Such an embodiment could be used in a food packaging application in a grocery store. Or, the ink could be formulated to undergo different color changes at different temperatures, by, for example, incorporating mixtures of liquid crystal materials in the ink. Or the inks could be tailored to exhibit more intense color in specific wavelengths, such as, for example, green, red, or blue. All of these variants of the present invention are largely dependent on the materials and amounts used in a formulation, with the cholesteryl derivatives being one of the main drivers in controlling these color changes.

In another embodiment, prints made with the inks of the present invention could be further overlaid with an overprint varnish (OPV), imparting increased resistance properties to the final print construct. The inks of the present invention could be used in a single layer, or in multiple layers, and also may include other ink layers that are outside the compositional details of the present invention.

In the present invention, a thermochromic liquid crystal ink is developed which shows a temperature dependent color change based on a cholesteric phase.

In certain embodiments, when the liquid crystals are incorporated into an ink film, which is coated onto a substrate and allowed to reach room temperature (about 18° to 25° C.), then a colorless or a light white/grey film can be seen because most cholesteryl derivatives, such as cholesteryl esters are white-transparent crystals. On a black background, which is one of the preferred backgrounds for this system due to its ability to enhance visual color change, typically only the black color appears prior to color change.

In another embodiment, the liquid crystals are incorporated into an ink film, which is coated onto a substrate and allowed to reach a cold temperature (e.g. less than 20° C., less than 10° C., less than 0° C.), then a colorless or light white/grey film can be seen. The ink exhibits a reversible colored appearance when the temperature is elevated above the original cold temperature.

In certain embodiments, when the ink containing the liquid crystals is heated, the crystals melt completely and first form a colorless liquid (isotropic phase). If the heat source is removed, the molten cholesteryl derivative cools down to a cholesteric phase before it re-crystallizes. In this cholesteric phase, the cholesteryl derivative starts to crystalize, but still has properties of a liquid. In this phase, the single crystals become rod-shaped (especially in the case of cholesteryl benzoate) which are orientated in the same direction in a layer. Provided that the liquid crystal material is chiral, the crystallized layers turn in the direction of the chirality.

These polarized crystalline layers stack many times to each other, and turn many times around their own axis in a helical long-range order. The pitch or periodicity is normally several hundreds of nanometers. Typically, the periodicity is in the range of visible light, e.g. 380 nm to 700 nm, and can change with temperature and pressure. Pressure sensitive liquid crystals exhibit a piezochromic effect and change color in response to a threshold pressure (e.g. a piezochromic polymer). It is to be understood that, in addition to the thermochromic liquid crystal cholesteryl derivatives, the inks and coatings of the present invention may also comprise materials that exhibit a piezochromic effect. The length of the periodicity (i.e. the distance between cholesteric liquid crystals of the same orientation) determines the wavelength of light that is reflected. A cholesteric liquid crystal will reflect light with wavelength corresponding to the periodicity, while the light with a wavelength other than the periodicity of the helical long-range order is transmitted through the liquid crystal. The wavelength can change with the type of cholesteryl derivative used, and the cholesteric phase (which is close to the melting point of the liquid crystal), and can be influenced with a mixture of similar cholesteryl derivatives.

The advantage of the inks of the present invention is the use of non-encapsulated liquid crystal pigments. This allows for more efficient production of the inks, such as faster production time, and reduced energy requirements. Encapsulation of substances is a known process in which particles or droplets are surrounded by a coating to give capsules. The major disadvantage to the encapsulation process is the requirement for a separate transformation process, which consumes resources (material, energy, time, production capacity, etc.), and is thus less advantageous than processes that avoid the need for encapsulation. Although the ink and coating compositions of the present invention preferably include non-encapsulated liquid crystals, it would be possible to further incorporate encapsulated colorants.

Suitable cholesteryl derivates include, but are not limited to, Unsubstituted Cholesterol, Cholesterol Acetate, Cholesterol Propionate, Cholesterol Butyrate, Cholesterol Valerate, Cholesterol Hexanoate, Cholesterol Heptanoate, Cholesterol n-Octanoate, Cholesterol Pelargonate (i.e. cholesteryl nonanoate), Cholesterol Decanoate, Cholesterol Laurate, Cholesterol Myristate, Cholesterol Palmitate, Cholesterol Stearate, Cholesterol Formate, Cholesterol Chloroformate, Cholesterol Hydrogen Succinate, Cholesterol Oleate, Cholesterol Linoleate, Cholesterol Benzoate, Cholesterol 2,4-Dichlorobenzoate, Cholesterol Hydrogen Phthalate, Cholesterol Phenylacetate, Cholesterol Hydrocinnamate, Cholesterol trans-Cinnamate, Cholesteryl Bromide, Cholesteryl Chloride, Cholesterol Methyl Carbonate, Cholesterol Ethyl Carbonate, Cholesterol Isopropyl Carbonate, Cholesterol Butyl Carbonate, Cholesterol Isobutyl Carbonate, Cholesterol Amyl Carbonate, Cholesterol Hexyl Carbonate, Cholesterol Heptyl Carbonate, Cholesterol n-Octyl Carbonate, Cholesterol Nonyl Carbonate, Cholesterol Oleyl Carbonate, and combinations thereof. As it is known that different cholesteric materials impart different color shades and differing color intensity, a formulator could arrive at tailored color change effects based on customer demands through routine experimentation.

Cholesterol and/or cholesteryl derivatives are typically each individually present in the ink and coating compositions (i.e. where at least one other resin and at least one solvent, other than cholesterol and/or cholesteryl derivatives, is in the formulation) in an amount of about 1 wt % to about 30 wt %, based on the total weight of the composition. For example, the cholesterol and/or cholesteryl derivatives may each individually be present in an amount of about 1 wt % to about 25 wt %, based on the total weight of the composition; or about 1 wt % to about 20 wt %; or about 1 wt % to about 15 wt %; or about 1 wt % to about 10 wt %; or about 1 wt % to about 5 wt %; or about 5 wt % to about 30 wt %; or about 5 wt % to about 25 wt % or about 5 wt % to about 20 wt % or about 5 wt % to about 15 wt % or about 5 wt % to about 10 wt %; or about 10 wt % to about 30 wt %; or about 10 wt % to about 25 wt %; or about 10 wt % to about 20 wt %; or about 10 wt % to about 15 wt %; or about 15 wt % to about 30 wt %; or about 15 wt % to about 25 wt %; or about 15 wt % to about 20 wt %; or about 20 wt % to about 30 wt %; or about 20 wt % to about 25 wt %; or about 25 wt % to about 30 wt %. A single cholesterol and/or cholesteryl derivative may be used, or a combination of cholesterol and/or cholesteryl derivatives may be used, provided that the total amount of cholesterol and/or cholesteryl derivatives is about 1 wt % to about 30 wt %.

In mixtures of neat cholesterol and/or cholesteryl derivatives (i.e. only cholesterol and/or cholesteryl derivatives are included in the formulation), any amount of each individual cholesterol and/or cholesteryl derivative may be included in the formulation, as long as the total wt % totals 100 wt %.

In a solution of a mixture of cholesterol and/or cholesteryl derivatives (one or more) with one or more solvents, the ratio of cholesterol and/or cholesteryl derivatives to solvent may be 0.1:1 to 2:1. For example, ratio may be about 0.5:1 to 1:1.

The neat cholesteryl materials of the present invention, each individually or combinations thereof, typically have an anisotropic to mesophase threshold transition temperature TLC1 of about −20° C. to about 100° C. For example, the neat cholesteryl materials of the present invention may have a TLC1 of about −20° C. to about 90° C.; or about −20° C. to about 80° C.; or about −20° C. to about 70° C.; or about −20° C. to about 60° C.; or about −20° C. to about 50° C.; or about −20° C. to about 40° C. or about −20° C. to about 30° C.; or about −20° C. to about 20° C. or about −20° C. to about 10° C.; or about −20° C. to about 0° C.; or about −20° C. to about −10° C.; or about −10° C. to about 100° C.; or about −10° C. to about 90° C.; or about −10° C. to about 80° C.; or about −10° C. to about 70° C.; or about −10° C. to about 60° C.; or about −10° C. to about 50° C.; or about −10° C. to about 40° C.; or about −10° C. to about 30° C.; or about −10° C. to about 20° C.; or about −10° C. to about 10° C.; or about −10° C. to about 0° C.; or about 0° C. to about 100° C.; or about 0° C. to about 90° C.; or about 0° C. to about 80° C.; or about 0° C. to about 70° C.; or about 0° C. to about 60° C.; or about 0° C. to about 50° C.; or about 0° C. to about 40° C.; or about 0° C. to about 30° C.; or about 0° C. to about 20° C.; or about 0° C. to about 10° C.; or about 10° C. to about 100° C.; or about 10° C. to about 90° C.; or about 10° C. to about 80° C.; or about 10° C. to about 70° C.; or about 10° C. to about 60° C.; or about 10° C. to about 50° C.; or about 10° C. to about 40° C.; or about 10° C. to about 30° C.; or about 10° C. to about 20° C.; or about 20° C. to about 100° C.; or about 20° C. to about 90° C.; or about 20° C. to about 80° C.; or about 20° C. to about 70° C.; or about 20° C. to about 60° C.; or about 20° C. to about 50° C.; or about 20° C. to about 40° C.; or about 20° C. to about 30° C.; or about 30° C. to about 100° C.; or about 30° C. to about 90° C. or about 30° C. to about 80° C.; or about 30° C. to about 70° C.; or about 30° C. to about 60° C.; or about 30° C. to about 50° C.; or about 30° C. to about 40° C.; or about 40° C. to about 100° C.; or about 40° C. to about 90° C.; or about 40° C. to about 80° C.; or about 40° C. to about 70° C. or about 40° C. to about 60° C.; or about 40° C. to about 50° C.; or about 50° C. to about 100° C.; or about 50° C. to about 90° C.; or about 50° C. to about 80° C.; or about 50° C. to about 70° C.; or about 50° C. to about 60° C.; or about 60° C. to about 100° C.; or about 60° C. to about 90° C.; or about 60° C. to about 80° C.; or about 60° C. to about 70° C.; or about 70° C. to about 100° C.; or about 70° C. to about 90° C.; or about 70° C. to about 80° C.; or about 80° C. to about 100° C.; or about 80° C. to about 90° C.; or about 90° C. to about 100° C.

The neat cholesteryl materials of the present invention, each individually or combinations thereof, typically have a mesophase to isotropic phase threshold transition TLC2 temperature of about −19° C. to about 125° C. For example, the cholesteryl materials may have a TLC2 of about −19° C. to 120° C.; or about −19° C. to about 110° C.; or about −19° C. to about 100° C.; or about −19° C. to about 90° C.; or about −19° C. to about 80° C.; or about −19° C. to about 70° C.; or about −19° C. to about 60° C.; or about −19° C. to about 50° C.; or about −19° C. to about 40° C.; or about −19° C. to about 30° C.; or about −19° C. to about 20° C.; or about −19° C. to about 10° C.; or about −19° C. to about 0° C.; or about −19° C. to about −10° C.; or about −10° C. to about 125° C.; or about −10° C. to about 120° C.; or about −10° C. to about 110° C.; or about −10° C. to about 100° C.; or about −10° C. to about 90° C.; or about −10° C. to about 80° C.; or about −10° C. to about 70° C.; or about −10° C. to about 60° C.; or about −10° C. to about 50° C.; or about −10° C. to about 40° C.; or about −10° C. to about 30° C.; or about −10° C. to about 20° C.; or about −10° C. to about 10° C.; or about −10° C. to about 0° C.; or about 0° C. to about 125° C.; or about 0° C. to about 120° C.; or about 0° C. to about 110° C.; or about 0° C. to about 100° C.; or about 0° C. to about 90° C.; or about 0° C. to about 80° C.; or about 0° C. to about 70° C.; or about 0° C. to about 60° C.; or about 0° C. to about 50° C.; or about 0° C. to about 40° C.; or about 0° C. to about 30° C.; or about 0° C. to about 20° C.; or about 0° C. to about 10° C.; or about 10° C. to about 125° C.; or about 10° C. to about 120° C.; or about 10° C. to about 110° C.; or about 10° C. to about 100° C.; or about 10° C. to about 90° C.; or about 10° C. to about 80° C.; or about 10° C. to about 70° C.; or about 10° C. to about 60° C.; or about 10° C. to about 50° C.; or about 10° C. to about 40° C.; or about 10° C. to about 30° C.; or about 10° C. to about 20° C.; or about 20° C. to about 125° C.; or about 20° C. to about 120° C.; or about 20° C. to about 110° C.; or about 20° C. to about 100° C.; or about 20° C. to about 90° C.; or about 20° C. to about 80° C.; or about 20° C. to about 70° C.; or about 20° C. to about 60° C.; or about 20° C. to about 50° C.; or about 20° C. to about 40° C.; or about 20° C. to about 30° C.; or about 30° C. to about 125° C.; or about 30° C. to about 120° C.; or about 30° C. to about 110° C.; or about 30° C. to about 100° C.; or about 30° C. to about 90° C. or about 30° C. to about 80° C.; or about 30° C. to about 70° C.; or about 30° C. to about 60° C.; or about 30° C. to about 50° C.; or about 30° C. to about 40° C.; or about 40° C. to about 125° C.; or about 40° C. to about 120° C.; or about 40° C. to about 110° C.; or about 40° C. to about 100° C.; or about 40° C. to about 90° C.; or about 40° C. to about 80° C.; or about 40° C. to about 70° C. or about 40° C. to about 60° C.; or about 40° C. to about 50° C.; or about 50° C. to about 125° C.; or about 50° C. to about 120° C.; or about 50° C. to about 110° C.; or about 50° C. to about 100° C.; or about 50° C. to about 90° C.; or about 50° C. to about 80° C.; or about 50° C. to about 70° C.; or about 50° C. to about 60° C.; or about 60° C. to about 125° C.; or about 60° C. to about 120° C.; or about 60° C. to about 110° C.; or about 60° C. to about 100° C.; or about 60° C. to about 90° C.; or about 60° C. to about 80° C.; or about 60° C. to about 70° C.; or about 70° C. to about 125° C.; or about 70° C. to about 120° C.; or about 70° C. to about 110° C.; or about 70° C. to about 100° C.; or about 70° C. to about 90° C.; or about 70° C. to about 80° C.; or about 80° C. to about 125° C.; or about 80° C. to about 120° C.; or about 80° C. to about 110° C.; or about 80° C. to about 100° C.; or about 80° C. to about 90° C.; or about 90° C. to about 125° C.; or about 90° C. to about 120° C.; or about 90° C. to about 110° C.; or about 90° C. to about 100° C.; or about 100° C. to about 125° C.; or about 100° C. to about 120° C.; or about 100° C. to about 110° C.; or about 110° C. to about 125° C.; or about 110° C. to about 120° C.; or about 120° C. to about 125° C.

The neat cholesteryl materials of the present invention, each individually or combinations thereof, typically have a bandwidth WLC (i.e. TLC2−TLC1) of about 1° C. to about 25° C. For example, the value of WLC of the neat cholesteryl materials may be about 1 to about 20; or about 1 to about 15; or about 1 to about 10; or about 1 to about 5; or about 5 to about 25; or about 5 to about 20; or about 5 to about 15; or about 5 to about 10; or about 10 to about 25; or about 10 to about 20; or about 10 to about 15; or about 15 to about 25; or about 15 to about 20; or about 20 to about 25.

Other resins could be used in conjunction with the cholesteryl derivatives, and there is no particular limitation on the type of resin used. Suitable resin types include, but are not limited to, alkyd, acrylic, cellulose, nitrocellulose, ethyl cellulose, ketonic, polyurethane, polyamide, vinyl, polyvinyl butyral, rosin ester, hydrocarbon, epoxy, polyester, styrene, urea, melamine-formaldehyde, combinations thereof, and the like.

When included, these other resins are typically present in the ink and coating compositions of the present invention in an amount of about 1 wt % to about 55 wt %, based on the total weight of the composition. For example, these other resins may each individually be present in an amount of about 1 wt % to about 50 wt %, based on the total weight of the composition; or about 1 wt % to about 45 wt %; or about 1 wt % to about 40 wt %; or about 1 wt % to about 35 wt %; or about 1 wt % to about 30 wt %; or about 1 wt % to about 25 wt %; or about 1 wt % to about 20 wt %; or about 1 wt % to about 15 wt %; or about 1 wt % to about 10 wt %; or about 1 wt % to about 5 wt %; or about 5 wt % to about 55 wt %; or about 5 wt % to about 50 wt %; or about 5 wt % to about 45 wt %; or about 5 wt % to about 40 wt %; or about 5 wt % to about 35 wt %; or about 5 wt % to about 30 wt %; or about 5 wt % to about 25 wt %; or about 5 wt % to about 20 wt %; or about 5 wt % to about 15 wt %; or about 5 wt % to about 10 wt %; or about 10 wt % to about 55 wt %; or about 10 wt % to about 50 wt %; or about 10 wt % to about 45 wt %; or about 10 wt % to about 40 wt %; or about 10 wt % to about 35 wt %; or about 10 wt % to about 30 wt %; or about 10 wt % to about 25 wt %; or about 10 wt % to about 20 wt %; or about 10 wt % to about 15 wt %; or about 15 wt % to about 55 wt %; or about 15 wt % to about 50 wt %; or about 15 wt % to about 45 wt %; or about 15 wt % to about 40 wt %; or about 15 wt % to about 35 wt %; or about 15 wt % to about 30 wt %; or about 15 wt % to about 25 wt %; or about 15 wt % to about 20 wt %; or about 20 wt % to about 55 wt %; or about 20 wt % to about 50 wt %; or about 20 wt % to about 45 wt %; or about 20 wt % to about 40 wt %; or about 20 wt % to about 35 wt %; or about 20 wt % to about 30 wt %; or about 20 wt % to about 25 wt %; or about 25 wt % to about 55 wt %; or about 25 wt % to about 50 wt %; or about 25 wt % to about 45 wt %; or about 25 wt % to about 40 wt %; or about 25 wt % to about 35 wt %; or about 25 wt % to about 30 wt %; or about 30 wt % to about 55 wt %; or about 30 wt % to about 50 wt %; or about 30 wt % to about 45 wt %; or about 30 wt % to about 40 wt %; or about 30 wt % to about 35 wt %; or about 35 wt % to about 55 wt %; or about 35 wt % to about 50 wt %; or about 35 wt % to about 45 wt %; or about 35 wt % to about 40 wt %; or about 40 wt % to about 55 wt %; or about 40 wt % to about 50 wt %; or about 40 wt % to about 45 wt %; or about 45 wt % to about 55 wt %; or about 45 wt % to about 50 wt %; or about 50 wt % to about 55 wt %. A single resin may be used, or a combination of resins, provided that the total amount of resins other than cholesteryl materials is between 1 wt % and 55 wt %. The resins may be supplied as a material containing 5 wt % solids (the remainder being solvent) to 100 wt % solids (i.e. no solvent).

Solvents used in the ink and coating compositions of the present invention include those that are typically used in solvent-based ink systems. A single solvent or a combination of solvents may be used. Suitable solvents include, but are not limited to aliphatic hydrocarbons, cyclic hydrocarbons, aromatic hydrocarbons, ketones, aldehydes, alcohols and polyols, ethers, esters, heterocyclic organic solvents, glycerin, combinations thereof, and the like.

Solvents are present in the ink and coating compositions of the present invention in an amount of about 1 wt % to about 80 wt %, based on the total weight of the composition. For example, solvents may be present in an amount of about 1 wt % to about 70 wt %, based on the total weight of the composition; or about 1 wt % to about 60 wt %; or about 1 wt % to about 50 wt %; or about 1 wt % to about 40 wt %; or about 1 wt % to about 30 wt %; or about 1 wt % to about 20 wt %; or about 1 wt % to about 10 wt %; or about 10 wt % to about 80 wt %; or about 10 wt % to about 70 wt %; or about 10 wt % to about 60 wt %; or about 10 wt % to about 50 wt %; or about 10 wt % to about 40 wt %; or about 10 wt % to about 30 wt %; or about 10 wt % to about 20 wt %; or about 20 wt % to about 80 wt %; or about 20 wt % to about 70 wt %; or about 20 wt % to about 60 wt %; or about 20 wt % to about 50 wt %; or about 20 wt % to about 40 wt %; or about 20 wt % to about 30 wt %; or about 30 wt % to about 80 wt %; or about 30 wt % to about 70 wt %; or about 30 wt % to about 60 wt %; or about 30 wt % to about 50 wt % or about 30 wt % to about 40 wt %; or about 40 wt % to about 80 wt %; or about 40 wt % to about 70 wt %; or about 40 wt % to about 60 wt %; or about 40 wt % to about 50 wt %; or about 50 wt % to about 80 wt %; or about 50 wt % to about 70 wt %; or about 50 wt % to about 60 wt %; or about 60 wt % to about 80 wt %; or about 60 wt % to about 70 wt %; or about 70 wt % to about 80 wt %. A single solvent may be used, or a combination of solvents may be used, provided that the total amount of solvents is 1 wt % to 80 wt %.

The ink and coating compositions of the present invention are essentially free of water. The compositions of the present invention may comprise less than 10 wt % water, based on the total weight of the composition. In a preferred embodiment, the compositions of the invention do not contain any water.

The ink and coating compositions of the present invention may further comprise traditional colorants. Suitable colorants include, but are not limited to, organic or inorganic pigments and dyes. The dyes include but are not limited to fluorescent dyes, azo dyes, anthraquinone dyes, xanthene dyes, azine dyes, combinations thereof and the like. Organic pigments may be one pigment or a combination of pigments, such as for instance Pigment Yellow Numbers 12, 13, 14, 17, 74, 83, 114, 126, 127, 174, 188; Pigment Red Numbers 2, 22, 23, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; and/or Pigment Green Number 7. Inorganic pigments may be one of the following non-limiting pigments: iron oxides, titanium dioxides, chromium oxides, ferric ammonium ferrocyanides, ferric oxide blacks, Pigment Black Number 7 and/or Pigment White Numbers 6 and 7. Other organic and inorganic pigments and dyes can also be employed, as well as combinations that achieve the colors desired. When included, traditional colorants may be present in the ink and coating compositions of the present invention in an amount of about 0.5 wt % to about 20 wt %.

As with most ink and coating compositions, additives may be incorporated to enhance various properties. Additives include, but are not limited to, adhesion promoters, silicones, light stabilizers, de-gassing additives, ammonia, flow promoters, defoamers, antioxidants, stabilizers, surfactants, dispersants, plasticizers, rheological additives, waxes, silicones, etc. The inks of the present invention may contain the usual extenders, such as clay, talc, calcium carbonate, magnesium carbonate, or silica. When present, additives and extenders may be present in the compositions of the present invention in an amount of about 0.5 wt % to about 5 wt %.

The compositions of the invention (i.e. ink and coating compositions comprising one or more cholesteryl materials, one or more resins other than cholesteryl materials, and one or more solvents) typically have an anisotropic phase to mesophase threshold transition temperature T1 of about −20° C. to about 100° C. For example, the compositions of the present invention may have a T1 of about −20° C. to about 90° C.; or about −20° C. to about 80° C.; or about −20° C. to about 70° C.; or about −20° C. to about 60° C.; or about −20° C. to about 50° C.; or about −20° C. to about 40° C. or about −20° C. to about 30° C.; or about −20° C. to about 20° C. or about −20° C. to about 10° C.; or about −20° C. to about 0° C.; or about −20° C. to about −10° C.; or about −10° C. to about 100° C.; or about −10° C. to about 90° C.; or about −10° C. to about 80° C.; or about −10° C. to about 70° C.; or about −10° C. to about 60° C.; or about −10° C. to about 50° C.; or about −10° C. to about 40° C.; or about −10° C. to about 30° C.; or about −10° C. to about 20° C.; or about −10° C. to about 10° C.; or about −10° C. to about 0° C.; or about 0° C. to about 100° C.; or about 0° C. to about 90° C.; or about 0° C. to about 80° C.; or about 0° C. to about 70° C.; or about 0° C. to about 60° C.; or about 0° C. to about 50° C.; or about 0° C. to about 40° C.; or about 0° C. to about 30° C.; or about 0° C. to about 20° C.; or about 0° C. to about 10° C.; or about 10° C. to about 100° C.; or about 10° C. to about 90° C.; or about 10° C. to about 80° C.; or about 10° C. to about 70° C.; or about 10° C. to about 60° C.; or about 10° C. to about 50° C.; or about 10° C. to about 40° C.; or about 10° C. to about 30° C.; or about 10° C. to about 20° C.; or about 20° C. to about 100° C.; or about 20° C. to about 90° C.; or about 20° C. to about 80° C.; or about 20° C. to about 70° C.; or about 20° C. to about 60° C.; or about 20° C. to about 50° C.; or about 20° C. to about 40° C.; or about 20° C. to about 30° C.; or about 30° C. to about 100° C.; or about 30° C. to about 90° C. or about 30° C. to about 80° C.; or about 30° C. to about 70° C.; or about 30° C. to about 60° C.; or about 30° C. to about 50° C.; or about 30° C. to about 40° C.; or about 40° C. to about 100° C.; or about 40° C. to about 90° C.; or about 40° C. to about 80° C.; or about 40° C. to about 70° C. or about 40° C. to about 60° C.; or about 40° C. to about 50° C.; or about 50° C. to about 100° C.; or about 50° C. to about 90° C.; or about 50° C. to about 80° C.; or about 50° C. to about 70° C.; or about 50° C. to about 60° C.; or about 60° C. to about 100° C.; or about 60° C. to about 90° C.; or about 60° C. to about 80° C.; or about 60° C. to about 70° C.; or about 70° C. to about 100° C.; or about 70° C. to about 90° C.; or about 70° C. to about 80° C.; or about 80° C. to about 100° C.; or about 80° C. to about 90° C.; or about 90° C. to about 100° C.

The compositions of the present invention typically have a mesophase to isotropic threshold transition temperature T2 of about −19° C. to about 125° C. For example, the compositions may have a T2 of about −19° C. to about 120° C.; or about −19° C. to about 110° C.; or about −19° C. to about 100° C.; or about −19° C. to about 90° C.; or about −19° C. to about 80° C.; or about −19° C. to about 70° C.; or about −19° C. to about 60° C.; or about −19° C. to about 50° C.; or about −19° C. to about 40° C.; or about −19° C. to about 30° C.; or about −19° C. to about 20° C.; or about −19° C. to about 10° C.; or about −19° C. to about 0° C.; or about −19° C. to about −10° C.; or about −10° C. to about 125° C.; or about −10° C. to about 120° C.; or about −10° C. to about 110° C.; or about −10° C. to about 100° C.; or about −10° C. to about 90° C.; or about −10° C. to about 80° C.; or about −10° C. to about 70° C.; or about −10° C. to about 60° C.; or about −10° C. to about 50° C.; or about −10° C. to about 40° C.; or about −10° C. to about 30° C.; or about −10° C. to about 20° C.; or about −10° C. to about 10° C.; or about −10° C. to about 0° C.; or about 0° C. to about 125° C.; or about 0° C. to about 120° C.; or about 0° C. to about 110° C.; or about 0° C. to about 100° C.; or about 0° C. to about 90° C.; or about 0° C. to about 80° C.; or about 0° C. to about 70° C.; or about 0° C. to about 60° C.; or about 0° C. to about 50° C.; or about 0° C. to about 40° C.; or about 0° C. to about 30° C.; or about 0° C. to about 20° C.; or about 0° C. to about 10° C.; or about 10° C. to about 125° C.; or about 10° C. to about 120° C.; or about 10° C. to about 110° C.; or about 10° C. to about 100° C.; or about 10° C. to about 90° C.; or about 10° C. to about 80° C.; or about 10° C. to about 70° C.; or about 10° C. to about 60° C.; or about 10° C. to about 50° C.; or about 10° C. to about 40° C.; or about 10° C. to about 30° C.; or about 10° C. to about 20° C.; or about 20° C. to about 125° C.; or about 20° C. to about 120° C.; or about 20° C. to about 110° C.; or about 20° C. to about 100° C.; or about 20° C. to about 90° C.; or about 20° C. to about 80° C.; or about 20° C. to about 70° C.; or about 20° C. to about 60° C.; or about 20° C. to about 50° C.; or about 20° C. to about 40° C.; or about 20° C. to about 30° C.; or about 30° C. to about 125° C.; or about 30° C. to about 120° C.; or about 30° C. to about 110° C.; or about 30° C. to about 100° C.; or about 30° C. to about 90° C. or about 30° C. to about 80° C.; or about 30° C. to about 70° C.; or about 30° C. to about 60° C.; or about 30° C. to about 50° C.; or about 30° C. to about 40° C.; or about 40° C. to about 125° C.; or about 40° C. to about 120° C.; or about 40° C. to about 110° C.; or about 40° C. to about 100° C.; or about 40° C. to about 90° C.; or about 40° C. to about 80° C.; or about 40° C. to about 70° C. or about 40° C. to about 60° C.; or about 40° C. to about 50° C.; or about 50° C. to about 125° C.; or about 50° C. to about 120° C.; or about 50° C. to about 110° C.; or about 50° C. to about 100° C.; or about 50° C. to about 90° C.; or about 50° C. to about 80° C.; or about 50° C. to about 70° C.; or about 50° C. to about 60° C.; or about 60° C. to about 125° C.; or about 60° C. to about 120° C.; or about 60° C. to about 110° C.; or about 60° C. to about 100° C.; or about 60° C. to about 90° C.; or about 60° C. to about 80° C.; or about 60° C. to about 70° C.; or about 70° C. to about 125° C.; or about 70° C. to about 120° C.; or about 70° C. to about 110° C.; or about 70° C. to about 100° C.; or about 70° C. to about 90° C.; or about 70° C. to about 80° C.; or about 80° C. to about 125° C.; or about 80° C. to about 120° C.; or about 80° C. to about 110° C.; or about 80° C. to about 100° C.; or about 80° C. to about 90° C.; or about 90° C. to about 125° C.; or about 90° C. to about 120° C.; or about 90° C. to about 110° C.; or about 90° C. to about 100° C.; or about 100° C. to about 125° C.; or about 100° C. to about 120° C.; or about 100° C. to about 110° C.; or about 110° C. to about 125° C. or about 110° C. to about 120° C.; or about 120° C. to about 125° C.

The compositions of the present invention typically have a bandwidth W (i.e. T2−T1) of about 1° C. to about 25° C. For example, the value of W of the compositions may be about 1 to about 20; or about 1 to about 15; or about 1 to about 10; or about 1 to about 5; or about 5 to about 25; or about 5 to about 20; or about 5 to about 15; or about 5 to about 10; or about 10 to about 25; or about 10 to about 20; or about 10 to about 15; or about 15 to about 25; or about 15 to about 20; or about 20 to about 25.

### EXAMPLES

The following examples illustrate specific aspects of the present invention, and are not intended to limit the scope thereof in any respect, and should not be so construed.

### Examples 1 to 4. Cholesteryl Derivative Mixtures

A mixture of cholesteryl esters (i.e. cholesteryl benzoate and cholesteryl nonanoate) and cholesteryl oleyl carbonate were heated to 190° C., and subsequently cooled to room temperature. The formulation of Examples 1 to 4 is shown in Table 1.

TABLE 1
Formulation of Examples 1 to 4.

| | Ex. 1 | Ex. 2 | Ex. 3 | Ex. 4 |
|---|---|---|---|---|
| Liquid crystal mixture | wt % | wt % | wt % | wt % |
| Cholesteryl benzoate | 10 | 10 | 10 | 10 |
| Cholesteryl nonanoate | 25 | 45 | 50 | 60 |
| Cholesteryl oleyl carbonate | 65 | 45 | 40 | 30 |
| Total | 100 | 100 | 100 | 100 |

The mixtures were coated, using a 12 μm rod, on the surface of a paperboard carton substrate that was pre-printed with a black ink to help accentuate the color change effect. It should be noted that any black ink or other colored ink could be pre-printed on the substrate, or the liquid crystal mixtures could be coated directly onto an unprinted substrate. The coatings were cooled down to room temperature for about 1 minute. The coated substrates were heated and/or cooled to determine the anisotropic to mesophase threshold transition temperature TLC1, and the mesophase to isotropic threshold transition temperature TLC2. The bandwidth WLC (TLC2−TLC1) was calculated. The results are shown in Table 2.

TABLE 2
Transition temperatures and bandwidth of Examples 1 to 4

| | Ex. 1 | Ex. 2 | Ex. 3 | Ex. 4 |
|---|---|---|---|---|
| TLC1 (° C.) | 17.0 | 26.0 | 32.0 | 37.0 |
| TLC2 (° C.) | 23.0 | 30.0 | 35.0 | 40.0 |
| Bandwidth WLC | 6 | 4 | 5 | 3 |
| (TLC2-TLC1) | | | | |

The coatings of cholesteryl derivative mixtures exhibited color change between TLC1 and TLC2, and reversed back to the original colorless appearance outside this range. As the temperature increases within the given range, the color shifts in accordance with the color spectrum: colorless (anisotropic)→red→orange→yellow→green→blue→indigo→violet→colorless (isotropic). When the liquid crystal mixture is in a molten (isotropic) state, the color change (thermochromic effect) appears as soon as the molten cholesteryl derivative crystallizes to the intermediate mesophase. As the cholesteryl derivative cools further, the color disappears as the material transitions to a fully crystalline, anisotropic state.

According to a preferred embodiment, wherein the reversible ink exhibits color change in accordance with the heat generated from human touch, Examples 2 and 3 showed the best thermochromic effect in this range. Examples 2 and 3 became intensely colorful when the board was touched by fingers from the backside, due to the increased temperature generated by the touch. Thus, the relative ratios of cholesteryl derivatives of Example 2 were used in subsequent experiments. However, it should be noted that although Examples 2 and 3 are optimized embodiments, Examples 1 and 4 would be suitable for use as well, as are mixtures based on other cholesteryl derivative materials.

From the results above, it could be shown that a thermochromic effect appears when the molten cholesteryl-mixture crystalizes by cooling to room temperature. Therefore the effect should also appear when a cholesteryl-mixture solution in a solvent crystalizes out, when the solvent evaporates. The thermochromic effect appears as soon as the cholesteryl mixture crystalizes and it does not matter if the crystallization starts because of cooling of a molten mixture, or because of evaporating of the solvent from a cholesteryl solution.

### Example 5. Cholesteryl Derivatives Dissolved in Solvents

It was determined that the same color change effect can be realized when the cholesteryl derivative mixtures further include one or more solvents that evaporate during the drying stage, and the mixtures crystalize from a solution when the solvent evaporates.

The Example 2 cholesteryl derivative mixture formulation was dissolved in ethyl acetate, using a magnetic lab mixer, to provide Example 5. The ratio of cholesteryl derivative:ethyl acetate was 1:2, as this solvent easily dissolves this cholesteryl derivative mixture in high concentration, and does not require heating to dissolve the cholesteryl derivative mixture. Example 5 was coated, with a 12 μm rod, on the surface of a black carton and air dried at room temperature for about one minute. The thermochromic effect was again tested, as the board was touched from the backside with the fingers. A colorful and strong thermochromic effect appeared. The color changed from blue (warm) to green, yellow, and red (cold) and finally to colorless of black again respectively.

### Example 6. Thermochromic Finished Ink

A finished thermochromic ink based on Example 2 (i.e. essentially maintaining the same relative ratios of cholesteryl derivatives), which was dissolved in ethyl acetate, and mixed with varnish to provide Example 6 finished ink. The formulation of Example 6 is shown in Table 3.

TABLE 3
Formulation of Example 6 thermochromic finished ink

| Material | Ex. 6 wt % |
|---|---|
| Cholesteryl benzoate | 1.2 |
| Cholesteryl nonanoate | 9.1 |
| Cholesteryl oleyl carbonate | 9.1 |
| Ethyl acetate | 40.3 |
| Varnish 13787 | 32.3 |
| Varnish 13736 | 8.0 |
| Total | 100.0 |
| T1 (° C.) | 25 |
| T2 (° C.) | 30 |
| W (T2-T1) | 5 |

Cholesteryl derivatives were all supplied by Aldrich.
Varnish 13787: acrylic resin in isopropyl acetate; 40% solids (Sun Chemical Switzerland, Niederwangen, department F&E).
Varnish 13736: alkyd resin in ethanol; 69% solids (Sun Chemical Switzerland, Niederwangen, department F&E).

Example 6 finished ink was printed on black pre-printed paperboard using a 12 μm rod, and air dried at room temperature for about 1 minute. Example 6 finished ink exhibited a strong liquid crystal thermochromic effect.

### Examples 7 to 11. Thermochromic Finished Inks

Our studies showed that different cholesteryl derivatives and other varnishes are also suitable for providing a finished ink. The only requirement for the additional varnish is that it is compatible with the liquid cholesteryl derivatives and does not destroy the thermochromic properties of the finished ink. Examples 7 to 11 had good thermochromic effects comparable to Example 6. The formulations of Examples 7 to 11 are shown in Table 4. The surface of the finished inks was rated as follows:
1—neither sticky nor greasy
2—slightly greasy
3—slightly sticky
4—very greasy, like lubricating grease
5—very sticky, like honey

The surface ratings are also shown in Table 4.

TABLE 4
Formulations of Examples 7 to 11 thermochromic finished inks

| | Ex. 7 | Ex. 8 | Ex. 9 | Ex. 10 | Ex. 11 |
|---|---|---|---|---|---|
| Materials | wt % | wt % | wt % | wt % | wt % |
| Cholesteryl | 1.67 | 1.51 | 1.21 | 1.21 | 1.21 |
| benzoate | | | | | |
| Cholesteryl | 7.36 | 11.36 | 9.07 | 9.07 | 9.07 |
| nonanoate | | | | | |
| Cholesteryl oleyl | 7.36 | 11.36 | 9.07 | 9.07 | 9.07 |
| carbonate | | | | | |
| Ethyl-acetate | 33.44 | 50.52 | 40.33 | 40.33 | 40.33 |
| Varnish 13714 | 50.17 | | | | |
| Varnish 13787 | | 25.25 | 32.26 | 36.29 | 32.26 |
| Varnish 13736 | | | 8.06 | | |
| Varnish 13730 | | | | 4.03 | 8.06 |
| Total | 100 | 100 | 100 | 100 | 100 |
| Surface rating | 3 | 2 | 1-2 | 1-2 | 1-2 |

Varnish 13714: nitrocellulose resin in isopropyl acetate; 10% solids (Sun Chemical Switzerland, Niederwangen, department F&E).
Varnish 13730: ethylcellulose resin in isopropyl acetate/ethanol (1:1); 20% solids (Sun Chemical Switzerland, Niederwangen, department F&E).

Thermochromic finished ink Example 7: Example 7 was coated on a black pre-printed paperboard carton with a 12 μm rod, and dried at room temperature for about 1 minute. The thermochromic effect was good (i.e. fast, colorful effect by touching with the fingers from the backside of the board). But, because the surface is sticky (see Table 4), it would be disadvantageous to print this ink on a printing press. Due to the sticky surface of Example 7, it would be preferable to use an overprint varnish with this example.

Thermochromic finished ink Example 8: This version was optimized with the respect to the solubility of the cholesteryl derivatives. With this thermochromic ink version in varnish 13787, a black pre-printed paperboard carton was coated with a 12 μm rod. The surface of the dry substrate was a bit greasy (see Table 4), and the thermochromic effect was good. Example 8 could be printed on a printing press, but may be subject to smearing.

Thermochromic finished ink Example 9: The same experiment was performed with varnish 13736, which leads to a very sticky surface, but the thermochromic effect appeared to be fluorescent. Because of the positive influence of the varnish 13736 (brighter color), a mixture of both varnish 13787 and varnish 13736 was successfully tested and the varnish content was increased to reduce the greasy touch on the board surface, and to get more fluorescent colors. Preferably, Example 9 ink would be overprinted with an OPV to alleviate the slightly greasy surface.

Thermochromic finished ink Examples 10 and 11: The same experiment was performed with varnish 13730 (ethyl cellulose), which also leads to a fluorescent and bright thermochromic effect, but with a sticky surface. The same experiment as above was subsequently carried out with a mixture of varnish 13787 and varnish 13730 in two different ratios (see Table 4). The thermochromic effect on the printed black carton was readily visible with Examples 10 and 11, though not as strong as in Example 9.

Example 9 represents a preferred embodiment as it exhibits good thermochromic properties while being minimally sticky. The viscosity of Example 9 was measured at 16 seconds (#4 DIN cup), but this is merely a convenient coating viscosity for the ensuing tests. It should be noted that the viscosity could be altered by well accepted formulation methods (e.g. more/less solvent, higher viscosity varnish, etc.) to make the ink suitable for various printing and coating methods.

Substrate: The optimized Example 9 was tested on various pre-printed substrates to determine on which background color the thermochromic effect becomes most pronounced. For this, a black rough, black smooth, silver, red, gold matte, white, blue, and a green pre-printed paperboard were tested. The best board for the thermochromic effect was black rough, followed by the red, green, and blue board. Generally, it can be said, that the darker the board, the better the thermochromic effect, but there is no limitation or requirement for the background color of the substrate, and indeed could be the virgin color of the substrate itself without alteration.

Overprint varnish (OPV): Because the surfaces of the coated paperboards were still slightly sticky or slightly greasy, various overprint varnishes were tested, and coated over the dry thermochromic inks. The results of the overprint varnishes coated over Example 9 are shown in Table 5. The overprint varnishes were coated with a 6 μm rod, and dried over the top of the paperboard first printed with Example 9 dried thermochromic ink.

TABLE 5
Effect of overprint varnishes on surface properties

| Overprint Varnish | |
|---|---|
| (OPV)¹ | Observation |
| Solvent-based | Dry surface². Thermochromic effect is visible. |
| Varnish 13787 | |
| Water-based OPV | Dry surface. Thermochromic effect is visible, |
| 232761-01 | even after one month (RK-Proofer³) |
| Water-based OPV | Dry surface. Thermochromic effect is visible. |
| 230972-00 | (RK-Proofer) |
| Water-based OPV | Dry surface. Thermochromic effect is visible, |
| 248726-00 | even after one month (RK-Proofer) |
| Water-based OPV | Dry surface. Thermochromic effect is visible, |
| 248663-00 | even after one month (RK-Proofer) |
| UV-varnish | Dry surface. Thermochromic effect is visible. |
| 242041-00 | (RK-Proofer) |

¹(Available from Sun Chemical Switzerland, Niederwangen, department F&E)
²Dry surface indicates no greasy or sticky feel.
³RK-Proofer is a lab proofing instrument used to make high quality proofs using gravure, gravure-offset or flexo inks.

It should be noted that the OPV's shown in Table 5 are merely exemplary, and in no way should be viewed as limiting. Any OPV that dries to a non-sticky, non-greasy surface and does not immediately (or within an extended period, e.g. 1 month) destroy the thermochromic properties of the thermochromic liquid crystal inks beneath would be appropriate. This includes OPV's of the solvent-based, water-based, energy-curable, or hybrid variety.

### Examples 12 to 17. Thermochromic Finished Inks Formulated with One or Two Cholesteryl Derivatives

Further Examples 12 to 17 were prepared in which only one or two of the cholesteryl derivatives in Example 7 were used, and the thermochromic effects were investigated to understand the influences of the single cholesteryl esters in an ink mixture. The formulations and thermochromic rating of Examples 12 to 17 are shown in Table 6.

Thermochromic effect was rated as follows:
1=no thermochromic effect.
2=thermochromic effect (T1 and T2) temperature decreased.
3=thermochromic effect (T1 and T2) temperature increased.

TABLE 6
Formulations and thermochromic effect of Examples 12 to 17

| | Ex. | Ex. | Ex. | Ex. | Ex. | Ex. |
|---|---|---|---|---|---|---|
| | 12 | 13 | 14 | 15 | 16 | 17 |
| Materials | (wt %) | (wt %) | (wt %) | (wt %) | (wt %) | (wt %) |
| Cholesteryl | 1.21 | 1.21 | — | — | — | 19.36 |
| benzoate | | | | | | |
| Cholesteryl | 18.15 | — | 9.68 | — | 19.36 | — |
| nonanoate | | | | | | |
| Cholesteryl | — | 18.15 | 9.68 | 19.36 | — | — |
| oleyl carbonate | | | | | | |
| Ethyl-acetate | 40.32 | 40.32 | 40.32 | 40.32 | 40.32 | 40.32 |
| Varnish 13787 | 32.26 | 32.26 | 32.26 | 32.26 | 32.26 | 32.26 |
| Varnish 13736 | 8.06 | 8.06 | 8.06 | 8.06 | 8.06 | 8.06 |
| Total | 100 | 100 | 100 | 100 | 100 | 100 |
| Thermo- | 1 | 2 | 3 | 2 | 1 | 1 |
| chromic | | | | | | |
| effect rating | | | | | | |

These examples indicate that cholesteryl oleyl carbonate is the component mainly responsible for the thermochromic effect. Cholesteryl nonanoate slightly increased the temperature for the thermochromic effect. Cholesteryl benzoate strongly decreased the temperature for the thermochromic effect. This knowledge allows the formulator to prepare finished inks with specific properties.

### Examples 18 and 19. Thermochromic Inks Formulated with Cholesteryl Acetate Instead of Cholesteryl Benzoate

Examples 18 and 19, which are suitable for gravure printing, were prepared to test alternative cholesteryl derivatives. Examples 18 and 19 were prepared similarly as described above, except that cholesteryl acetate was used instead of cholesteryl benzoate. The anisotropic to mesophase threshold transition temperature of the composition T1, and the mesophase to isotropic threshold transition temperature of the composition T2 were assessed by heating and/or cooling the coated substrates. The bandwidth W (T2−T1) was calculated. The formulations and thermochromic temperatures are shown in Table 7.

TABLE 7
Examples 18 and 19

| Ingredient | Ex. 18 (wt %) | Ex. 19 (wt %) |
|---|---|---|
| Cholesteryl Oleyl Carbonate | 3.56 | 12.85 |
| Cholesteryl nonanoate | 9.34 | 4.82 |
| Cholesteryl Acetate | 0.58 | 2.01 |
| Ethyl-acetate | 57.67 | 40.16 |
| Varnish 13787 | 23.07 | 32.13 |
| Varnish 13736 | 5.77 | 8.03 |
| Total | 100.00 | 100.00 |
| T1 (° C.) | 42 | 3 |
| T2 (° C.) | 47 | 7 |
| Bandwidth (T2-T1) | 5 | 4 |

Cholesteryl acetate was purchased from Sigma Aldrich.

Example 18 thermochromic ink is adjusted for higher temperature applications. Example 19 thermochromic ink is adjusted for lower temperature applications.

### Example 20. Thermochromic Ink Formulated with Cholesteryl Stearate Instead of Cholesteryl Nonanoate for Use in Screen Printing

Example 20 thermochromic ink was prepared similarly as described above, except that cholesteryl stearate was used instead of cholesteryl nonanoate. The formulation, T1, T2, and W are shown in Table 8.

TABLE 8
Thermochromic ink Example 20

| Ingredient | Ex. 20 wt % |
|---|---|
| Cholesteryl Oleyl Carbonate | 8.81 |
| Cholesteryl stearate | 8.73 |
| Cholesteryl Acetate | 0.71 |
| Dynoadd P506 6 μm stylrene-acrylate bead | 6.93 |
| (Polygon) (100% solids) | |
| Varnish 13736 | 12.47 |
| Degalan P24 n-butyl methacrylate binder | 28.78 |
| from Evonik (100% solids) | |
| Butyl glycol acetate | 28.78 |
| Ethyl acetate | 4.79 |
| Total | 100.00 |
| T1 (° C.) | 20 |
| T2 (° C.) | 26 |
| Bandwidth W (T2-T1) | 6 |

Cholesteryl stearate was purchased from Sigma Aldrich.

The last three components were mixed separately and then added to the solution of the rest of the components.

Example 20 thermochromic ink showed a thermochromic effect at room temperature.

### Example 21. Thermochromic Ink for Screen Printing

Example 21 was formulated to be suitable for screen printing. The formulation, T1, T2, and W are shown in Table 9.

TABLE 9
Example 21

| Ingredient | Ex. 21 wt % |
|---|---|
| Cholesteryl Oleyl Carbonate | 8.95 |
| Cholesteryl nonanoate | 8.95 |
| Cholesteryl Acetate | 1.40 |
| Dynoadd P506 6 μm stylrene-acrylate bead | 5.00 |
| (Polygon) (100% solids) | |
| Varnish 13736 | 8.95 |
| Butyl glycol acetate | 3.78 |
| Glycerine | 1.10 |
| Ethyl acetate | 17.11 |
| Degalan P24 n-butyl methacrylate binder | 20.66 |
| from Evonik (100% solids) | |
| Butyl glycol acetate | 20.66 |
| Ethyl acetate | 3.44 |
| Total | 100.00 |
| T1 (° C.) | 20 |
| T2 (° C.) | 26 |
| Bandwidth W (T2-T1) | 6 |

The last three components were mixed separately and then added to the solution of the rest of the components.

Example 21 thermochromic ink showed a thermochromic effect at room temperature.

The present invention has been described in detail, including the preferred embodiments thereof. However, it will be appreciated that those skilled in the art, upon consideration of the present disclosure, may make modifications and/or improvements on this invention that fall within the scope and spirit of the invention.

What is claimed is:

1. A method of providing a reversible thermochromic printed or coated substrate, comprising:
(a) providing a substrate;
(b) applying one or more layers of an ink or coating composition to the substrate, wherein the ink comprises;
i. one or more cholesteryl materials that are non-encapsulated; wherein each cholesteryl material has an anisotropic phase to mesophase threshold transition temperature TLC1, and a mesophase to isotropic phase threshold transition temperature TLC2;
ii. one or more organic solvents;
iii. one or more resins that are not cholesteryl materials; and
(c) drying the composition on the substrate to form a reversible thermochromic ink film.

2. The method of claim 1, wherein the composition comprises less than 10 wt % water, based on the total weight of the ink or coating composition.

3. The method of claim 2, wherein the composition has an anisotropic phase to mesophase threshold transition temperature T1, and a mesophase to isotropic phase threshold transition temperature T2.

4. The method of claim 3, wherein the substrate is selected from the group consisting of cellulose-based, paper, paperboard, fabric, leather, textiles, felt, concrete, masonry, stone, plastic, plastic or polymer film, glass, ceramic, metal, wood, composites, and combinations thereof.

5. The method claim 4, wherein the total amount of all cholesteryl materials is 1 wt % to 30 wt %, based on the total weight of the composition.

6. The method of claim 5, wherein the total amount of resins that are not cholesteryl materials is 1 wt % to 55 wt %, based on the total weight of the composition.

7. The method of claim 6, wherein the cholesteryl materials are selected from the group consisting of cholesteryl esters, cholesteryl carbonates, and combinations thereof.

8. The method of claim 7, wherein the one or more organic solvents are each individually selected from the group consisting of Aliphatic hydrocarbons, Cyclic hydrocarbons, Aromatic hydrocarbons, Ketones, Aldehydes, Alcohols, Polyols, Ethers, Esters, heterocyclic organic solvents, and combinations thereof.

9. The method of claim 8, further comprising one or more materials selected from the group consisting of additives, extenders, pigments, encapsulated pigments, dyes, and combinations thereof.

10. The method of claim 9, wherein each cholesteryl material individually has an anisotropic phase to mesophase threshold transition temperature TLC1 of −20° C. to 100° C.

11. The method claim 10, wherein each cholesteryl material individually has a mesophase to isotropic phase threshold temperature TLC2 of −19° C. to 125° C.

12. The method of claim 11, wherein each cholesteryl material individually has a mesophase temperature window TLC2−TLC1 of 1° C. to 25° C.

13. The method of claim 12, wherein the composition has a mesophase temperature window T2−T1 of 1° C. to 25° C.

14. The method of claim 13, wherein the composition exhibits a reversible color change as a result of elevating the temperature.

15. The method of claim 14, wherein T2 is greater than 0° C.

16. The method of claim 15, wherein T1 is less than 20° C.

17. The method of claim 16, wherein printing or coating is applied by a process selected from the group consisting of flexography, rotogravure, gravure, lithography, screen printing, curtain coating, roll coating, slot die coating and inkjet.

18. The method of claim 17, wherein the substrate is pre-printed with a colored ink.

19. The method of claim 18, further comprising applying an overprint varnish.

20. A printed or coated article resulting from the method claim 1.
